(19) United States
(12) Patent Application Publication
(10) Pub. No.: US 2004/0197648 A1
(43) Pub. Date: Oct. 7, 2004

(54) Self-storing battery handle

(75) Inventor: Jeffrey Sciutto, Columbus, IN (US)

Correspondence Address: Kevin H. Vanderleeden, Esq., McCormick, Paulding, Huber LLP, 185 Asylum Street, City Place II, Hartford, CT, 06103, US

(73) Assignee: HARDIGG INDUSTRIES, INC., South Deerfield, MA

(21) Appl. No.: 10/405,817

(22) Filed: Apr. 2, 2003

(51) Int. Cl. H01M 2/10

(52) U.S. Cl. 429/187; 429/16; 429/15

(57) ABSTRACT

A self-storing battery handle including a handle which may be selectively raised from a first position, where the handle is flush with, or below, a rim of the battery case, to a second position in which the handle extends above the rim of the battery case. The handle assembly further includes at least one stationary bracket extending outwardly from the battery case securing the handle to the battery case and guiding the handle's movement between the first and second positions.

### FIELD OF THE INVENTION

The present invention relates to handles for carrying batteries. More particularly, the invention relates to a battery handle that may be lowered into a storage position such that the handle need not be removed from the battery after installation thereof.

### BACKGROUND OF THE INVENTION

The use of handles for lifting and transporting unwieldy objects is well known. Starting, lighting, and ignition batteries used in automotive, recreational, and other applications, are heavy, cumbersome, and generally require two hands for carrying. As a result, many carrying devices or handles have been developed to facilitate the transport and installation of such batteries.

Existing battery handles are of several types such as plastic strap, molded and rope, each with inherent limitations. The plastic strap type of battery handle is generally a molded plastic strap that fits into holders molded into the battery case. This type of handle can slide into a rest position. The handle portion of the strap, however, is always located across the top of the battery. The location of the handle can limit access to the terminal areas and can interfere with the electrical wiring that is connected to the battery. For complete and unimpeded access, the handle must be removed. Removing this type of handle can be difficult due to the compact size of most battery installations. An example of a plastic strap type of battery handle can be found in a patent to Forrer (U.S. Pat. No. 5,670,274).

Molded handles are built into the cover of the battery. They are generally designed such that the handle folds down to a flush fit when the handle is stored. Molded handles provide access to the top of the battery and are generally fairly easy to install. However, the use of molded handles is limited to battery styles that have sufficient room in length, width, and depth of the battery cover to allow the handle to move to a stored position. Additionally, manufacturing molded handles involves a significant cost due to the assembly required during the cover manufacture. An example of a molded battery handle can be found in a patent to McCartney (U.S. Pat. No. 4,673,625).

Rope handles are attached to the outside of the battery cell. They operate as an aid in lifting the battery into or out of position. Rope handles, however, are not easily stored and can cause electrical problems if the handles are saturated with a conductive material and come into contact with a battery terminal. Additionally, removing a rope handle is a difficult task and, once removed, such handles can be difficult to reinstall. A patent to Buskirk (U.S. Pat. No. 3,092,520) discloses a rope battery handle.

Therefore a need exists for a movable battery handle that is easily stored, that allows a battery to be easily and quickly installed, and that is compact in size and inexpensive to manufacture.

### SUMMARY OF THE INVENTION

An object of the present invention is to provide a handle that does not need to be removed from a battery after installation of the battery.

A further object of the present invention is to provide a handle that is easily stored after installation of the battery and does not require a cover.

Another object of the present invention is to provide a handle that is low in cost and does not interfere with the battery electrically or mechanically.

Yet another object of the present invention is to provide a handle that is compact such that the battery may easily be placed into and removed from the installation space.

An additional object of the present invention is to provide a handle that can be retrofitted to an existing battery case.

Yet another object of the present invention is to provide a handle that can be easily colored or decorated for marketing and brand identification purposes.

The above objects are realized by the present invention, which is a self-storing handle assembly in which the handle may be easily moved from an operative position to a stored, inoperative position upon installation of the battery. In one embodiment, the handle assembly generally comprises at least one handle which may be selectively raised from a first position, where said handle is flush with or below a rim of the battery case, to a second position in which the handle extends above the rim of the battery case. The handle assembly further comprises a plurality of stationary brackets which extend outwardly from the battery case securing the handle to the battery case and guiding the handle's movement between the first and second positions.

The above discussed and other features and advantages of the present invention will be appreciated and understood by those skilled in the art from the following detailed description and drawings.

### BRIEF DESCRIPTION OF THE DRAWINGS

FIG. 1 is a perspective view of a battery case with the cover removed depicting the handle of the present invention in its inoperative position.

FIG. 2 is a perspective view of the handle of the present invention in its operative position.

FIG. 3 is an enlarged perspective view of the handle of the present invention in its operative position.

FIG. 4 is an enlarged perspective view of the handle of the present invention in its inoperative position.

FIG. 5 is a top view of the handle of the present invention.

FIG. 6 is a side view of the handle of the present invention in its inoperative position.

FIG. 7 is a side view of the handle of the present invention in its operative position.

FIG. 8 is a perspective view of an alternative embodiment of the handle of the present invention

### DETAILED DESCRIPTION OF THE PREFERRED EMBODIMENT

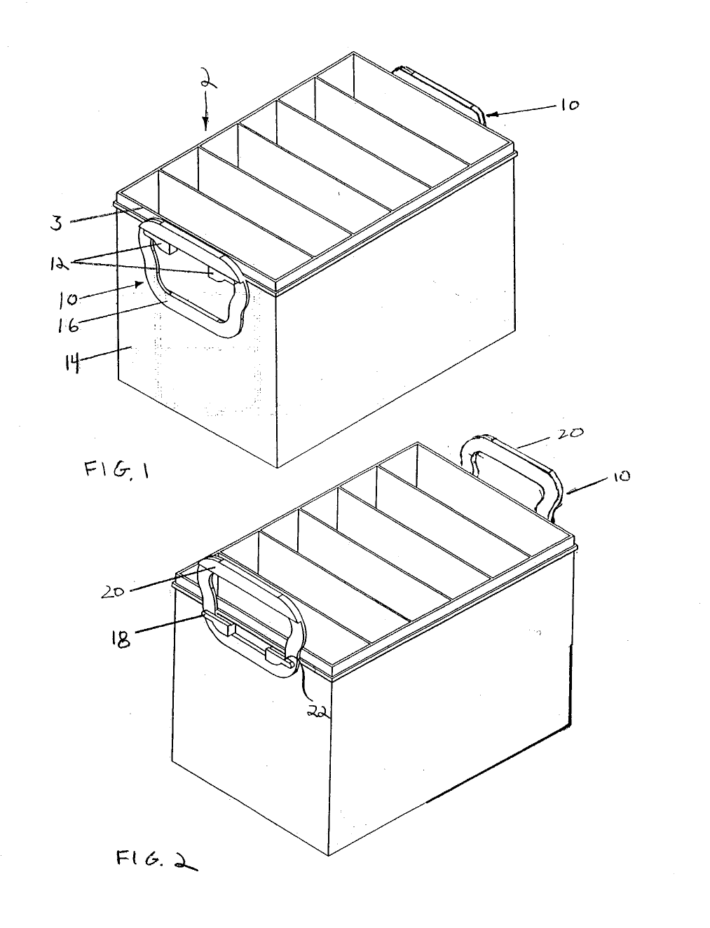

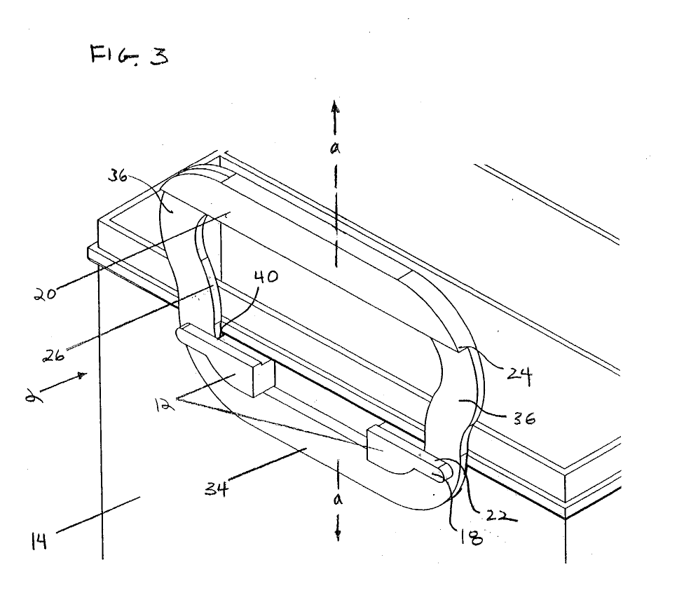

Referring to FIG.1, the preferred embodiment of the self-storing handle assembly 10 according to the present invention is shown. The handle assembly 10 comprises two stationery brackets 12 integrated into or molded to a side wall 14 of a battery case 2. As shown in FIG. 1 the battery case 2 has an edge or rim 3 along its upper surface. The handle assembly further comprises a movable handle 16 which is connected to the stationary brackets 12. The movable handle moves vertically from an inoperative or stored position, as shown in FIG. 1, to an operative position, as shown in FIG. 2, in which the handle is raised above the rim 3 of the battery case 2. As shown in FIGS. 1,2 and 5 the preferred embodiment of the present invention includes two handle assemblies 10, one per side wall 14 of the battery case 2, such that one may easily transport the battery.

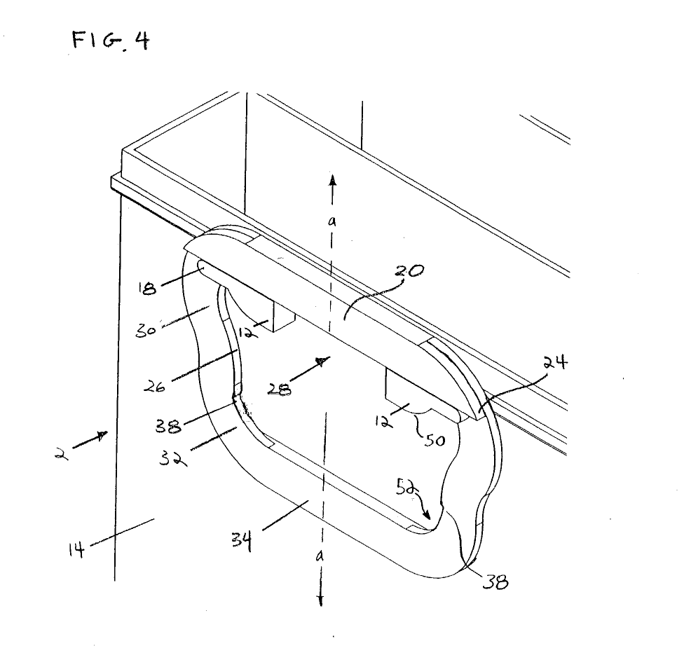

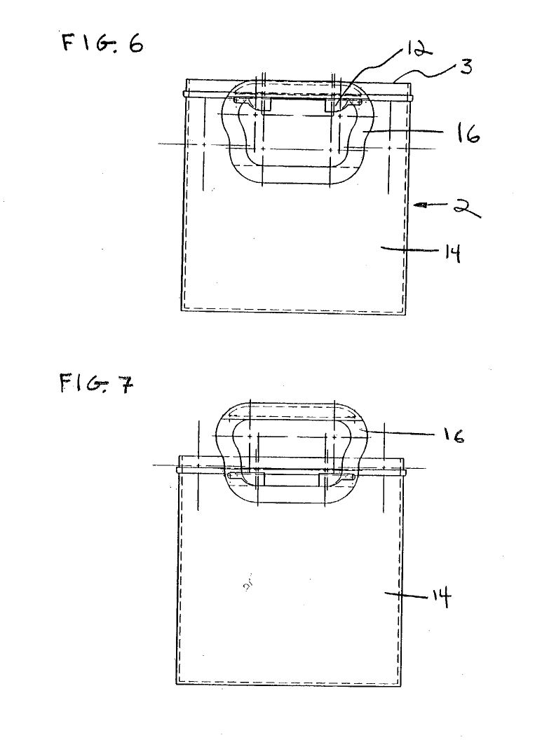

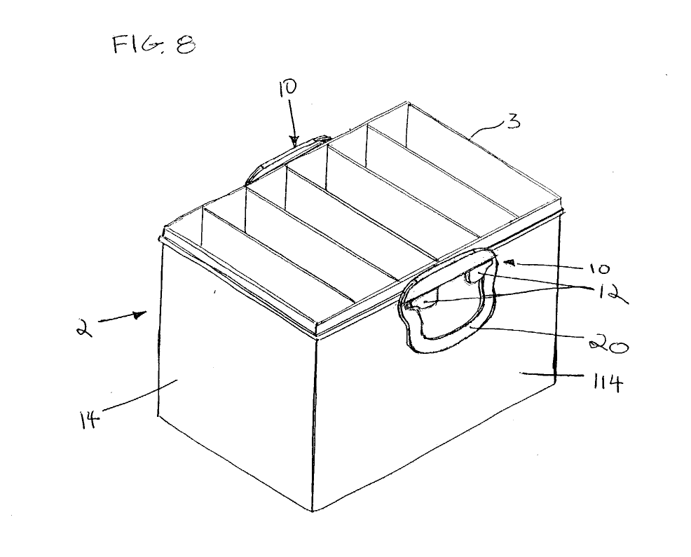

Referring to FIGS. 1-8, the movable handle 16 is a one-piece design with a gripping portion 20 adapted to be comfortably gripped by a user's hand. As shown in FIGS. 3 and 4, the movable handle further comprises convex side portions 28 and a bottom portion 30. The movable handle 16 also includes a protruding lip or stop member 24 on the outer surface of the gripping portion 20. As shown in FIGS. 3 and 4, the stop member 24 abuttingly engages the upper surfaces 22 of the stationary brackets 12 and functions as a stop to limit the vertical movement of the handle when it is lowered to its stored, inoperative position.

As shown in FIG. 4, the handle has an upper portion 30 which forms the gripping portion 20 of the handle and a lower portion 32. Preferably, the upper portion 30 is wider than the lower portion. The upper portion 30 is wider such that a user's hand may comfortably fit into the handle. The lower portion 32 is narrower so that it may fit within and be guided by the stationary brackets 12. Again referring to FIG. 4, the wider, upper portion 30 gradually narrows and then widens again forming convex inner handle surfaces 26.

Again referring to FIG. 4, the inner surfaces of the handle 16 also contain attachment or arresting means, such as notches, 38 molded into the inner surface. The notches 38 of the handle 16 function to secure the handle in its operative position. This is accomplished by an edge portion 40 of the stationary brackets 12 fitting into and engaging the notches 38.

Referring again to FIG. 4, the handle's 16 notches 38 are located on the inner surfaces of the handle which are of a width less than the handle surfaces directly adjacent to the inner surfaces. The varying widths of the surfaces give the handle a low profile and make it compact.

Referring to FIGS. 3 and 4, the stationary brackets 12 of the present invention are shown. The stationary brackets are permanently fixed to the battery case 2. In a preferred embodiment, the stationary brackets are integral to the battery case and part of the mold used to manufacture the case.

As shown in FIGS. 3 and 4, the stationary brackets 12 have arm or guide portions 18 which secure the handle 16 to the bracket 12 and guide its vertical movement. The guide portions 18 extend horizontally in an outward direction away from the opposite stationary bracket 12. Referring to FIG. 4, the stationary brackets 12 have a space 28 between the brackets such that when the handle is in its stored or inoperative position, as depicted in FIGS. 1 and 4, a user may place his fingers on the underside of the gripping portion 20 of the handle 16. The user may then raise the handle 16 to its operative position and remove and/or transport the battery.

Referring again to FIG. 4, the stationary brackets 12 have a bottom surface 50. The bottom surface is shaped such that it may fit into an inversely shaped mating surface 52 of the movable handle 16. The engagement of the bottom surfaces 50 with the mating surfaces 52 facilitates the secure fit of the edge portions 40 of the stationary brackets 12 within the notches 38 of the movable handle 16.

FIG. 8 depicts an alternative embodiment of the present invention in which the handle assemblies 10 are located on the front and back walls 114 of the battery case 2 as opposed to the side walls 14 of the battery case 2.

To use the handle of the present invention, one must first raise the movable handle 16 from a stored, inoperative position. This is accomplished by placing one's hand in the space 28 between the stationary brackets 12 and lifting up on the gripping portion 20 of the handle 16. One must then raise the handle 16 along its vertical path a (FIGS. 3 and 4). Near the top of the movable handle's vertical path the edge portions 40 of the stationary brackets 12 fit into and engage the notches 38 of the inner surface of the handle 16. The handle 16 is now fixed in its operative position and the battery may be lifted and carried.

Once the battery has been installed, the user must lower the handle 16 to its stored, inoperative position. To accomplish this, the user must push down on the handle 16 forcing the edge portions 40 of the stationary brackets 12 out of the notches 38 in the inner surface of the handle 16. The user must then lower the handle 16 along a vertical path a, until the stop member 24 of the handle 16 contacts and abuttingly engages the upper surfaces 22 of the stationary brackets 12 (FIGS. 3 and 4). The handle 16 is now in its stored, inoperative position.

To attach or remove the movable handle 16 to or from the brackets 12, the handle 16 is rotated approximately 45 degrees such that one of the stationary brackets aligns with the wider, upper portion 30 and the other bracket is situated near the narrower, lower portion 32. In this position, the handle 16 it may fit over the stationary brackets 12.

As shown in FIGS. 1 and 2, the preferred embodiment of the present invention features a battery case containing two handles, one on each side wall 14 of the case. Thus, to transport and install a battery, the user would raise and lower two handles.

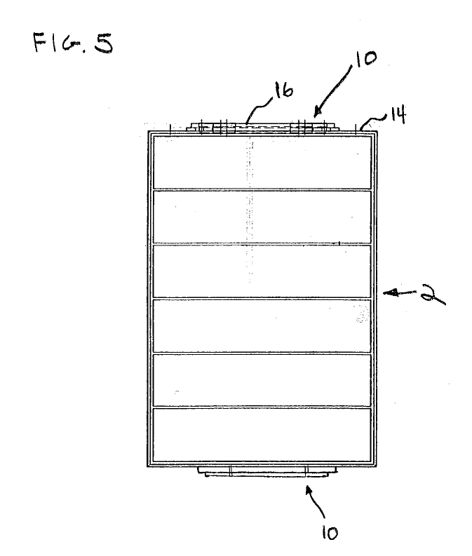

FIG. 5 shows a top view of the handle assembly 10. Referring to FIG. 5, the thickness of the handle assembly 10 should be such that the assembly does not protrude into the engine compartment or other installation space such that the battery may not easily be removed from or placed into the space. Preferably, there should be enough room on either side of the battery for a user to grasp the movable handle 16 and lower or raise the battery from the installation space.

The stationary brackets 12 and movable handle 16 may be manufactured in any battery Group Size and may be retrofitted to existing batteries by changing the mold used to manufacture the case of such batteries.

The stationary brackets 12 and the movable handle 16 may be made from a variety of materials, including but not limited to, polypropylene or any high strength thermoplastic material. Additionally, both the stationery brackets 12 and movable handle 16 may be manufactured by conventional molding processes suitable for use with thermoplastic materials.

The foregoing description is intended primarily for purposes of illustration. This invention may be embodied in other forms or carried out in other ways without departing from the spirit and scope of the invention. Modifications and variations still falling within the spirit and scope of the invention will be readily apparent to those of skill in the art.

What is claimed is:

1. A handle assembly disposed on a battery case for lifting and transporting a battery, said handle assembly comprising:
at least one handle which may be selectively raised from a first position where said handle is flush with or below a rim of said battery case to a second position in which said handle extends above said rim of said battery case; and
at least one stationary bracket fixed to said battery case which extends outward from said battery case, said stationary bracket secures said handle to said battery case and guides said handle's movement between said first position and said second position.

2. The handle assembly of claim 1 wherein said at least one stationary bracket is further comprised of an inner portion, an edge portion, a top surface and a bottom surface;

3. The handle assembly of claim 1 wherein said at least one stationary bracket is two stationary brackets;

4. The handle assembly of claim 1 wherein said handle is disengagable from said at least one stationary bracket.

5. The handle assembly of claim 2 wherein said handle is further comprised of an upper gripping portion, a lower portion which is substantially parallel to said upper gripping portion, and two arms which connect said upper gripping portion to said lower portion, said arms being substantially parallel to one another.

6. The handle assembly of claim 5 wherein said arms of said handle have notched side surfaces, said notched side surfaces engage said edge portions of the stationary brackets removably securing the handle in said second position.

7. The handle assembly of claim 5 wherein said handle is further comprised of a stop member disposed on said upper gripping portion, said stop member abuttingly engages said top surfaces of said at least one stationary bracket when said handle is in said first position.

8. The handle assembly of claim 3 wherein said two stationary brackets have a space between them such that a user may grasp said handle and raise said handle from said first position to said second position.

9. A movable handle in combination with a battery case comprising:
a battery case;
at least one handle which may be selectively raised from a first position where said handle is flush with or below a rim of said battery case to a second position in which said handle extends above said rim of said battery case; and at least one stationary bracket which extends outward from said battery case, said stationary bracket secures said handle to said battery case and guides said handle's movement between said first position and said second position.

10. The movable handle of claim 9 wherein said at least one stationary bracket is further comprised of an inner portion, an edge portion, a top surface and a bottom surface;

11. The movable handle of claim 9 wherein said at least one stationary bracket is two stationary brackets;

12. The movable handle of claim 10 wherein said handle is disengagable from said at least one stationary bracket.

13. The movable handle of claim 9 wherein said handle is further comprised of an upper gripping portion, a lower portion which is substantially parallel to said upper gripping portion, and two arms which connect said upper gripping portion to said lower portion, said arms being substantially parallel to one another.

14. The movable handle of claim 13 wherein said arms of said handle have notched side surfaces which engage said edge portion of the stationary bracket removably securing said handle in said second position.

15. The movable handle of claim 13 wherein said handle is further comprised of a stop member disposed on the outer surface of said upper gripping portion, said stop member abuttingly engages said top surfaces of said at least one stationary bracket when said handle is in said first position.

16. The movable handle of claim 11 wherein said two stationary brackets have a space between them such that a user may grasp said handle and raise said handle from said first position to said second position.

17. A handle assembly disposed on a battery case for lifting and transporting a battery, said handle assembly comprising:
at least one movable handle with a cross-section with a first side and a second side, said first side is of a greater width than said second side, said second side containing an arresting means to secure said handle in a first position in which said movable handle extends above the rim of said battery case.

18. The handle assembly of claim 17 further comprising two stationary brackets fixed to said battery case which extend outward from said battery case, said stationary brackets secure said movable handle to said battery case and guide said movable handle's movement between said first position and a second position in which the handle is flush with or below said rim of said battery case, said stationary brackets further comprising an inner portion, an edge portion, a top surface and a bottom surface, said edge portions of the stationary brackets engage said arresting means of said movable handle securing the handle in said first position.

19. The handle assembly of claim 18 wherein said arresting means is a notch.

20. The handle assembly of claim 18 wherein said two stationary brackets have a space between them such that a user may grasp said movable handle and raise said movable handle from said first position to said second position.
